(19) United States
(12) Patent Application Publication
(10) Pub. No.: US 2011/0233330 A1
(43) Pub. Date: Sep. 29, 2011

(54) DEVICE FOR GENERATING AERODYNAMIC RESISTANCE ON AN AIRCRAFT

(76) Inventor: Christian Breitsamter, Landsham (DE)

(21) Appl. No.: 13/082,075

(22) Filed: Apr. 7, 2011

Related U.S. Application Data
(63) Continuation of application No. PCT/EP2009/063172, filed on Oct. 9, 2009.

(30) Foreign Application Priority Data
Oct. 10, 2008 (EP) 08166306.4

(51) Int. Cl. B64C 9/32

(52) U.S. Cl. 244/113

(57) ABSTRACT

An aircraft comprises an airbrake which is disposed upstream in front of a vertical tail and which can be swung out into the airflow approaching the vertical tail. In order to reduce structure dynamic loads on the vertical tail, passages are formed in the brake flap.

### CROSS-REFERENCE TO RELATED APPLICATIONS

The present application is a continuation application of pending International patent application No. PCT/EP2009/063172 filed on Oct. 9, 2009, which designates the United States and claims priority from European patent application No. 08 166 306 filed on Oct. 10, 2008, the disclosure of each of which is hereby incorporated by reference it its entirety as part of the present disclosure.

### FIELD OF THE INVENTION

The invention relates to a device for generating aerodynamic resistance on an aircraft comprising at least one brake flap that can be swung out into an airflow approaching a vertical tail.

The invention moreover relates to an aircraft equipped with the device for generating aerodynamic resistance as well as to a method for generating aerodynamic resistance.

### BACKGROUND OF THE INVENTION

Such a device, aircraft and method are known from the publication BREITSAMTER, C: “Airbrake Induced Fin Buffet Loads on Fighter Aircraft”, in: ICAS 2006, 25th International Congress of the Aeronautical Science, 2006. The publication examines buffeting phenomena that occur during the use of airbrakes. Such airbrakes generally have brake flaps that can be swung out and which serve for abruptly reducing, in high-performance airplanes during maneuvering flight, the speed of the plane over a broad attack angle range. Such airbrakes can cause high structure dynamic loads on the components in the wake. In particular in the case of an airbrake disposed centrally and upstream of the vertical tail, structure dynamic peak loads may occur which are caused by the concurrence of the aerodynamic excitation due to broken-down leading edge vortices in the case of higher angles of attack and by turbulent wakes.

The flight envelope of highly maneuverable airplanes is typically limited by dynamic aeroelastic phenomena such as buffeting, buzzing and fluttering of wings and tail assemblies. Wings or wing components with a small aspect ratio and moderate to high leading edge angle sweep, such as they are typically used in such airplanes, generate a flow field with ordered leading edge vortices already at moderate angles of attack. On the one hand, the formation of leading edge vortices is intended because a significant lift gain as well as an increased useable attack angle range for enhancing maneuverability are obtained compared with an exclusively attached flow. On the other hand, a structural change in the vortex core, the vortex breakdown, occurs at higher angles of attack due to the increasing adverse pressure gradient. This becomes evident in an abrupt expansion of the vortex core cross section in conjunction with a flow that is highly turbulent downstream from the break-down point. A spiral-shaped instability prevailing in this case cause strong narrow-band speed and pressure fluctuations. These frequency-specific fluctuations can lead to buffeting on airplane or structural components directly or by induction. The unsteady air forces generated, for example, on the vertical tail typically lead to a structure excitation in the modes of the first bending and/or first torsion. Depending on the excitation intensity, this may result in a limitation of the flight envelope for the high attack angle range.

Moreover, a protective shield for an engine mounted on a fuselage which can be swung out from the airplane fuselage into an airflow approaching the engine is known from U.S. Pat. No. 4,165,849. This protective shield can also be used as an airbrake. Spring-loaded flaps are formed in the protective shield which are supposed to serve for avoiding cavitation-related problems in the engine.

### SUMMARY OF THE INVENTION

Proceeding from this prior art, the invention is therefore based on the object of providing a device for generating aerodynamic resistance in an airflow approaching a vertical tail of an aircraft which affects the flight envelope as little as possible. Furthermore, the invention is based on the object of providing a corresponding method.

These objects are accomplished by a device and a method comprising the features of the independent claims. Advantageous embodiments and developments are specified in the dependent claims.

In the device and the method, a brake flap is used which can be swung out into the airflow approaching the vertical tail and which is provided with at least one passage whose longitudinal axis extends transversely to a pivot axis of the brake flap and which serves for increasing the momentum of the air in the wake of the brake flap. Experiments showed that the turbulences in the wake of the brake flap and the periodic vortex separations can be reduced by means of such passages. The structure dynamic loads on the vertical tail can thus be kept low so that the flight envelope is hardly limited by the deployment of the brake flap.

In one embodiment of the device, the thickness of the brake flap decreases from an end close to the fuselage towards an end distant from the fuselage. The bending moments towards the end distant from the fuselage can thus be kept low.

In another embodiment, the at least one passage is formed by a slot formed in the brake flap which extends in the longitudinal direction from an end close to the fuselage to an end distant from the fuselage. It was found that the structure dynamic load on the vertical tail can be considerably reduced in particular by means of slots that extend from an end close to the fuselage to an end distant from the fuselage.

If the passage is disposed in the area of the brake flap distant from the fuselage, an attenuation of the structure dynamic loads on the fuselage is achieved in the high and very high attack angle range due to the fact that the intensity and the frequency concentration, in particular the periodicity of the pressure fluctuations of the axial vortex formation prevailing in the case of high angles of attack, are diminished in the wake of the brake flap. The passage distant from the fuselage, which is centered on a longitudinal axis of the brake flap, in this case preferably has a trapezoidal cross-sectional profile whose underside close to the fuselage has a width of between 0.25 B and 0.35 B of a base width B of the brake flap, whereas a top side of the passage distant from the fuselage has a width of between 0.15 B and 0.2 B of the base width B of the brake flap. The base width B of the brake flap is in this case supposed to mean the width of the brake flap at the end close to the fuselage. Moreover, the length L of the passage is to amount to between 0.25 L and 0.35 L of the length of the brake flap. It should be noted that the trapezoidal cross-sectional profile can also be rounded. In particular, the end distant from the fuselage and the end close to the fuselage of the passage can be formed to be arcuate or in the shape of a circle segment.

In contrast, in the case of smaller angles of attack, the structure dynamic load on the vertical tail can be reduced by providing at least two passages in an area of the brake flap close to the fuselage. The passages close to the fuselage reduce the intensity and the frequency concentration, in particular the periodicity of the pressure fluctuations of the vortex formation with vertically oriented vortex axes prevailing in the case of small angles of attack. The passages preferably have a rectangular cross section. In this case, the width of the passage is preferably between 0.1 B and 0.2 B of the base width B of the brake flap, whereas the length L of the passage is between 0.25 L and 0.35 L of the length of the brake flap. Moreover, the passage close to the fuselage is offset, relative to the longitudinal axis of the brake flap, by between 0.15 B and 0.25 B of a base width B of the brake flap. It should be noted that the rectangular cross section of the passages can also be rounded. In particular, the end close to the fuselage and the end distant from the fuselage of the passages can be formed to be arcuate or in the shape of a circle segment.

### BRIEF DESCRIPTION OF THE DRAWINGS

Further advantages and properties of the invention are apparent from the description below in which exemplary embodiments of the invention are explained in detail with reference to the drawing. In the figures:

FIG. 1 shows a front view of a high-performance airplane with a deployed airbrake;

FIG. 2 shows a perspective view of a deployed airbrake including the wake acting on a vertical tail of the high-performance airplane;

FIG. 3 shows a top view onto the brake flap of the airbrake;

FIG. 4 shows a side view of a vertical tail with the measuring points used in a measurement;

FIG. 5 is a diagram in which the surface-averaged pressure fluctuation intensity is shown as a function of the angle of attack for the cases with and without a deployment of the airbrake;

FIG. 6 is a diagram corresponding to FIG. 5 which illustrates the function of slot-shaped passages in the brake flap;

FIG. 7 is a diagram corresponding to FIG. 5 which illustrates the effect of a passage in the brake flap distant from the fuselage;

FIG. 8 is a diagram corresponding to FIG. 5 which illustrates the action of passages of the brake flap disposed in the area close to the fuselage;

FIG. 9 is a diagram with a power spectrum of the pressure fluctuations on the vertical tail when a brake flap is used with one passage distant from the fuselage and two close to the fuselage;

FIG. 10 is a diagram with a power spectrum of the pressure fluctuations on the vertical tail when a brake flap with one passage distant from the fuselage is used;

FIG. 11 is a diagram with a power spectrum of the pressure fluctuations on the vertical tail when a brake flap with a passage close to the fuselage is used; and

FIG. 12 is a diagram showing the relative change of the flow resistance coefficient for various designs of the brake flap.

### DETAILED DESCRIPTION OF THE INVENTION

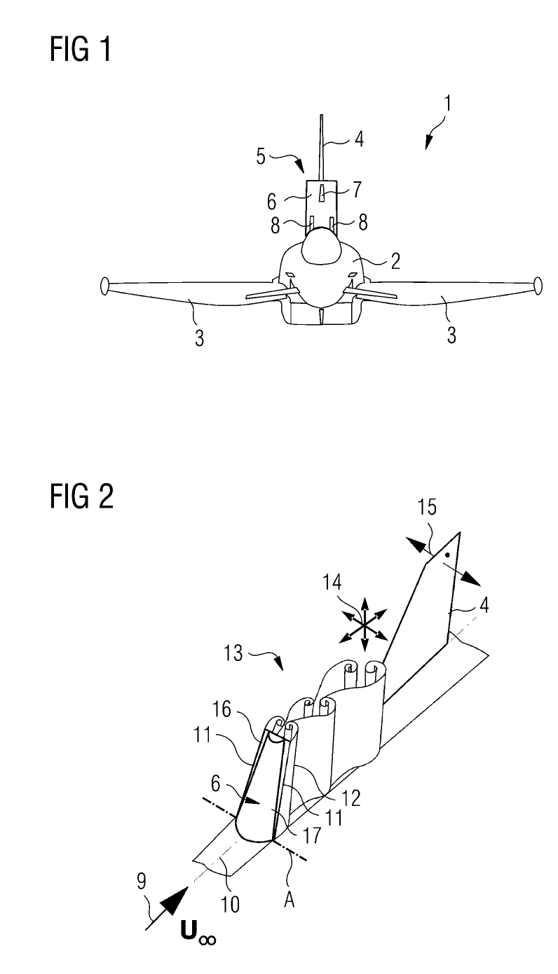

FIG. 1 shows a front view of an airplane 1 characterized by a particularly high maneuverability. The airplane 1 comprises a fuselage 2 and wings 3 that determine the wing span and have a strong sweep. In particular, the airplane 1 can be an airplane having delta wings. The airplane 1 further comprises a vertical tail 4 and an airbrake 5 which is mounted on the top side of the fuselage 2 and which comprises a brake flap 6 that can be swung out into the airflow approaching the vertical tail 4. A centrally disposed, slot-like passage 7 is formed into an area of the brake flap 6 distant from the fuselage. In contrast, two slot-like passages 8 disposed off-center are provided in an area of the brake flap 6 close to the fuselage. Thus, the passages 7 and 8 are disposed offset transversely to the longitudinal axis 18.

FIG. 2 shows a perspective view of the brake flap 6 which is swung out about a pivot axis A and which is approached by an airflow 9 with a velocity of approach u_{∞} along a longitudinal axis 10. In the process, air vortices 12 separate from the outer edges 11 of the brake flap 6, which form a turbulent wake 13 and lead to fluctuations 14 of the velocity and the pressure in the wake 13. Structural vibrations in the vertical tail 4 can be excited by the fluctuations 14. The structural vibrations 15 can include both torsional components as well as bending components.

It is noted that the front of the brake flap 6 approached by the airflow 9, with regard to its outer shape, resembles a truncated cone 17 placed on a rectangular base surface 16.

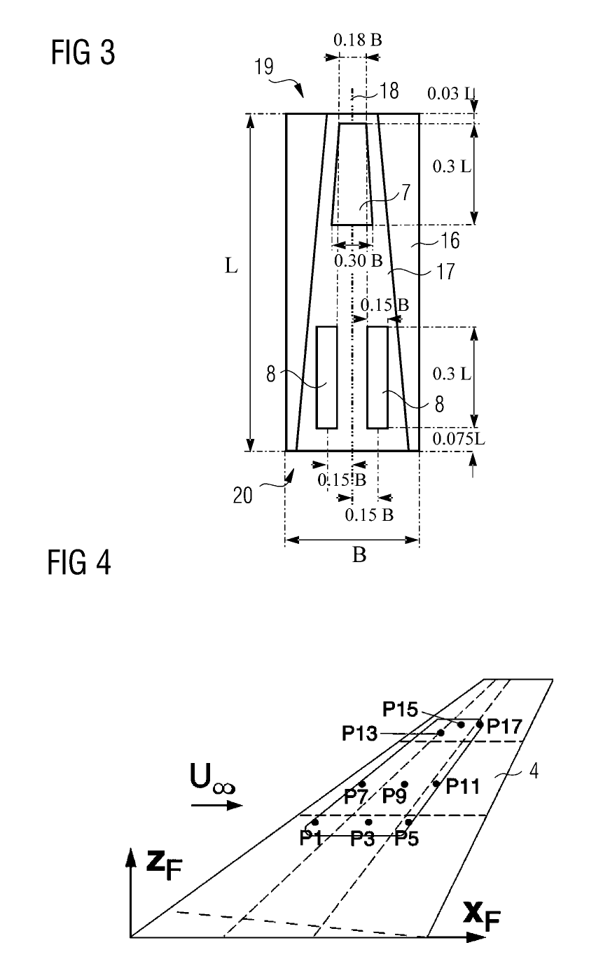

FIG. 3 shows a top view of the front of the brake flap 6 approached by the airflow 9. The base surface 16 and the truncated cone 17 placed on the base surface 16 is also discernible in FIG. 3. The brake flap 6 is formed symmetrical with respect to a central longitudinal axis 18. The passage 7 is disposed in the area of the end 19 of the brake flap 6 distant from the fuselage, whereas the passages 8 are located in the area of the end 20 close to the fuselage.

The base surface 16 of the brake flap 6 has a width B and a length L. The dimensions of the passage 7 preferably have a trapezoidal shape. The base of the passage 7 close to the fuselage in particular has a width in the range of from 0.25 to 0.35 B of the base width B of the brake flap 6, whereas the width of the side distant from the fuselage of the passage 7 is preferably in the range of from 0.15 to 0.25 B. The length of the passage 7 is preferably in the range of from 0.25 L and 0.35 L of the length L of the brake flap 6. The distance of the end distant from the fuselage of the passage 7 should be between 0.02 L and 0.05 L distant from the end distant from the fuselage.

The passages 8 close to the fuselage preferably have a rectangular cross section with a width of between 0.1 B and 0.2 B and a length of between 0.25 L and 0.35 L. The end of the passages 8 close to the fuselage is preferably disposed at a distance of between 0.05 L and 0.1 L to the end 20 close to the fuselage. For design-related reasons, it may also be necessary to dispose the passages 8 at a distance of up to 0.3 L from the end 20 close to the fuselage. Furthermore, the passages 8 close to the fuselage are offset with respect to the longitudinal axis 18 by between 0.15 and 0.25 B.

It is noted that the passages 8 close to the fuselage and the passage 7 distant from the fuselage can be rounded in the corners. In particular, the ends close to the fuselage and distant from the fuselage of the passages 7 and 8 can be configured completely arcuate or as an arc of a circle.

The exact position and size of the passages 7 and 8 as well as, optionally, the number of the passages 8 depend on the respective size and design of the brake flap 6, in particular on the wake to be expected with vortex separation as well as on the other flows about the fuselage 2 and the wings 3. Furthermore, the configuration of the passages 7 and 8 depend on the desired degree of attenuation and the acceptable loss of aerodynamic resistance of the brake flap 6. As a rule, the total cross-sectional surface area of the passages 7 and 8 formed in the brake flap 6 should not be greater than 25 percent of the cross-sectional surface area of the brake flap 6. If required, the loss of aerodynamic resistance can be compensated by enlarging the cross-sectional surface area of the brake flap 6.

In order to quantify the aerodynamic excitations, time series of the pressure difference between the pressure at the measurement position and the ambient pressure at different positions of the vertical tail 4 were recorded by unsteady pressure sensors. The positions of the pressure sensors are shown in FIG. 4. The wind channel model used was equipped with a total of eighteen pressure sensors. The pressure sensors were arranged at opposite locations on both sides of the vertical tail 4. The measurement locations are marked in FIG. 4 with the positions P1 to P17. The relative pressure at one of the measurement locations was converted into a pressure coefficient as a dimensionless quantity by reference to the stagnation pressure in front of the vertical tail 4. The mean value and the standard deviation cₚᵣₘₛ in the form of the mean square deviation were calculated from the time series of the pressure coefficients. The value of the standard deviation cₚᵣₘₛ thus represents the fluctuation intensity of the pressure coefficient. Large values of the standard deviation cₚᵣₘₛ signify a high degree of aerodynamic excitation, which entails a high structure dynamic load.

FIG. 5 shows a diagram in which the standard deviation cₚᵣₘₛ is plotted against the angle of attack α. A load curve 21 indicates the behavior of the standard deviation cₚᵣₘₛ if the brake flap 6 is not deployed. Another load curve 22 illustrates the behavior of the standard deviation cₚᵣₘₛ if the brake flap is swung out by a deflection angle of η_{AB}=60° whose shape corresponds to the shape of the brake flap 6, but which does not have any passages 7 and 8. Up to an angle of attack of about α≈10° the load curve 22 is above the load curve 21 by a constant value. Up to an angle of attack of about α≈10° the load curve 22 rises significantly and reaches an absolute maximum at an angle of attack of about α≈24°. As the angle of attack α grows, the load curve 22 drops steeply before the load curve 22 rises again, following the load curve 21.

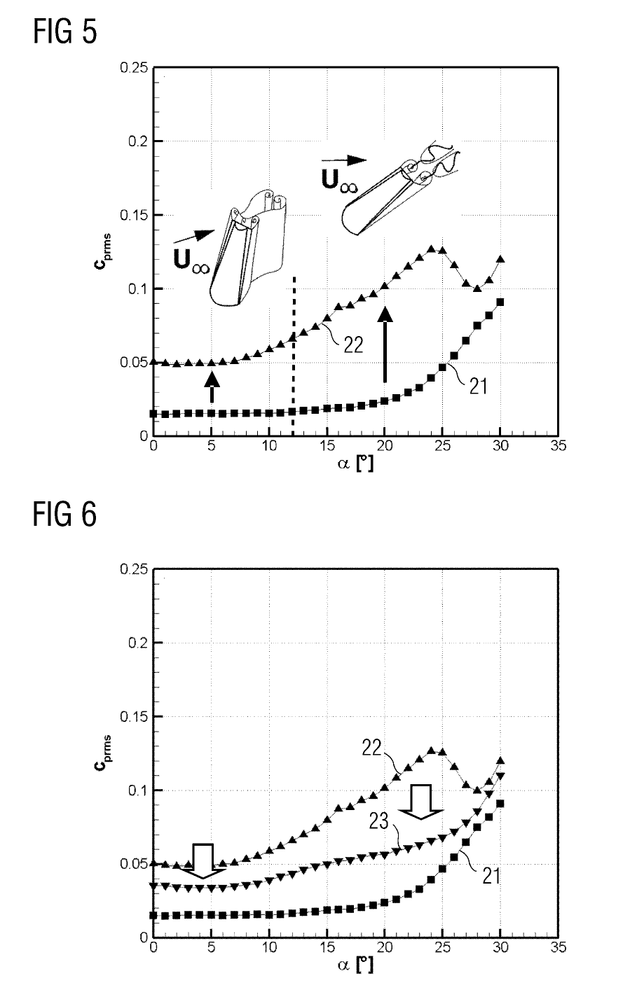

In FIG. 6, besides the load curve 21 and the load curve 22, another load curve 23 is drawn in which depicts the behavior of the standard deviation cₚₘᵣₛ during the use of the brake flap 6 with the passages 7 and 8. A comparison of the load curves 22 and 23 shows that the load is considerably reduced over the entire attack angle range owing to the passages 7 and 8. On average, the reduction is about 30 to 40 percent. Accordingly, the structure dynamic loads on the vertical tail 4 are reduced as well.

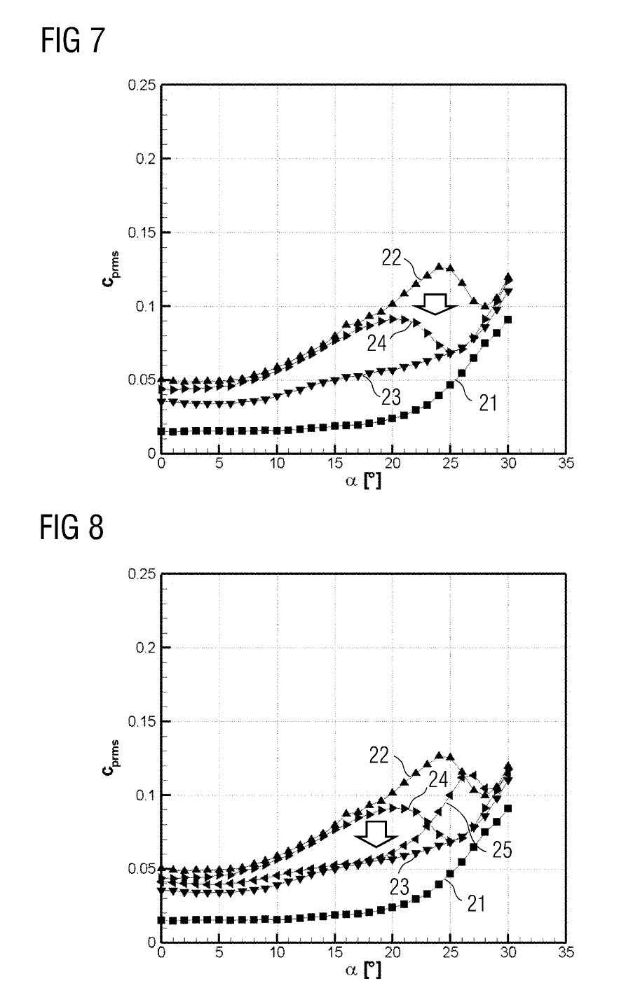

Due to the specific configuration of the passages 7 and 8, it is also possible to tune the reductions of the aerodynamic excitation to different attack angle ranges, which can be respectively assigned to different flow patterns of the wake 13 of the brake flap 6. In the high and very high attack angle range, in particular at α>12°, the increase of the momentum by means of the upper passage 7 causes a reduction because here, an axially oriented vortex flow prevails. This results from the effective angle of incidence at the outer edges 11 of the brake flap becoming ever smaller as the angle of attack α increases. In order to illustrate this, another load curve 24 is drawn in in FIG. 7 which indicates the behavior of the standard deviation cₚᵣₘₛ for the case that a brake flap is used which is only provided with a passage corresponding to the passage 7. It can clearly be seen in FIG. 7 that a reduction is achieved by means of the passage 7, in particular, in the high and very high attack angle range.

In contrast, in the low and moderate attack angle range, in particular in the case of angles of attack of up to α≈12°, a periodic vortex separation with vertically oriented vortex axes prevails, as it corresponds to the wake 13 of a bluff body. The dynamic excitation connected to this shape of a wake 13 can be reduced by the two slot-shaped passages 8. This reduction can be clearly seen in FIG. 8 and the load curve shown therein.

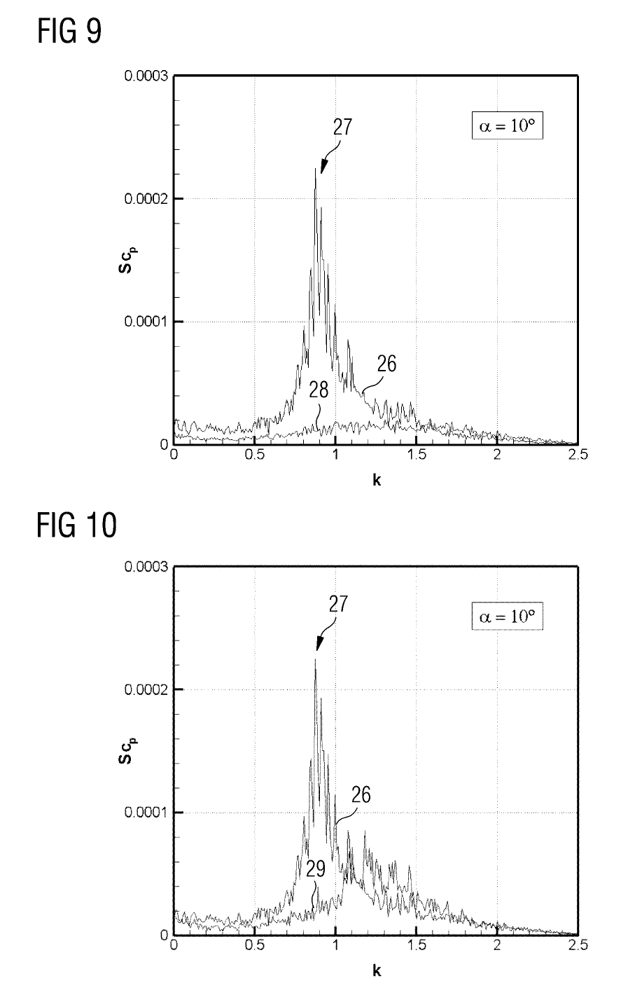

Besides the load curves shown in FIGS. 5 to 8, the power spectra of the pressure coefficient fluctuations are also of interest. The FIGS. 9 to 11 contain diagrams in which the spectral power density Scₚ of the pressure coefficient fluctuations at the position P13 on the tail assembly 4 is plotted against the reduced frequency k. The reduced frequency is in this case equal to the product of the frequency of the pressure coefficient fluctuations and the reference wing depth of the tail assembly 4, divided by the velocity of approach. The angle of attack α respectively is 10° and the deflection angle is η_{AB}=60°.

FIG. 9 shows, in particular, a power spectrum 26 of the pressure coefficient fluctuations when a brake flap without passages is used. The power spectrum 26 has fluctuation peaks 27 linked to dominant frequencies. Another power spectrum 28 depicted in FIG. 9 shows the spectral distribution of the pressure coefficient fluctuations in the case of the brake flap 6 with the passages 8 close to the fuselage and the passage 7 distant from the fuselage. It can be seen from FIG. 9 that the power spectrum 28 is below the power spectrum 26 by more than an order of magnitude in the area of the fluctuation peaks 27. The corresponding power spectra 26 and 28 prove that it is not just the fluctuation level on the whole, but primarily also the fluctuations that are connected with the vortex separations and accompanied by a dominant frequency that are reduced significantly. The power peaks in the pressure spectra associated with a dominant frequency are therefore reduced considerably.

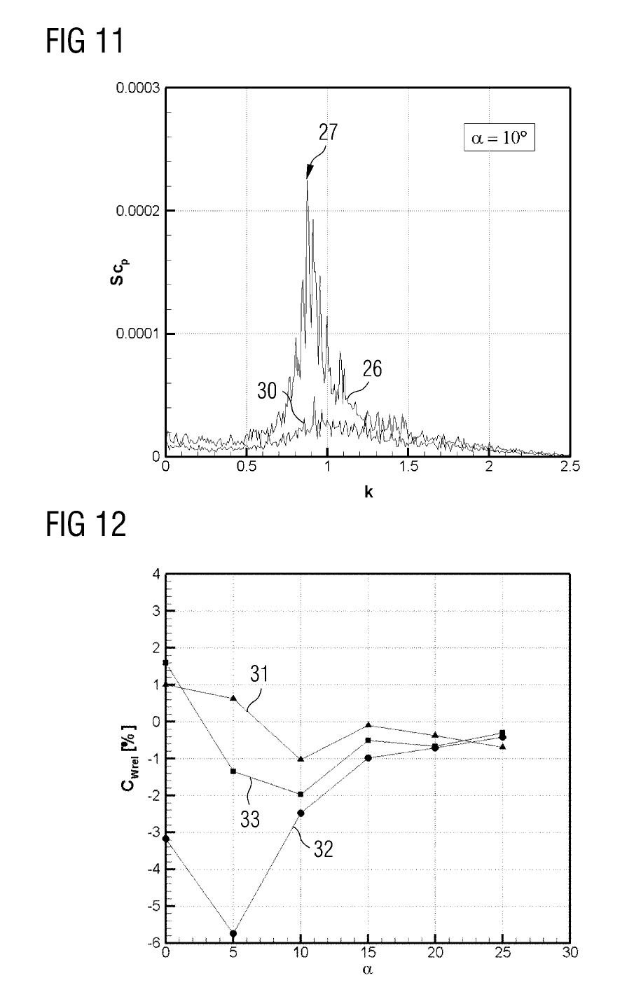

FIGS. 10 and 11 show further power spectra 29 and 30. The power spectrum 29 in FIG. 10 results if a brake flap is equipped with the passage 7 distant from the fuselage, whereas the power spectrum 30 depicted in FIG. 11 results if a brake flap is equipped only with the two passages 8 close to the fuselage. The result also in these two cases is a significant reduction of the fluctuation peaks 27.

It is noted that the reduction of the fluctuation peaks 27 is even more pronounced at larger angles of attack η_{AB}.

By using the slot-shaped passages 7 and 8 in the brake flap 6, the aerodynamic excitation on the structural elements located in the wake 13 can consequently be reduced substantially in high-performance airplanes. The size and position of the slot-shaped passages 7 and 8 of the brake flap 6 are in this case to be adapted to the prevailing geometry of the brake flap 6 and the flow conditions acting thereon, in particular to the periodic vortex wake and the occurrence of broken-down leading edge vortices.

The reduction of the drag connected with providing the passages 7 and 8 is small, as can be seen from FIG. 12. The relative change of the flow resistance coefficient c_{W} dependent on the angle of attack α in the case of a brake flap 6 swung out by a deflection angle η_{AB}=60° is shown in FIG. 12. The relative flow resistance coefficient c_{wrel} is in this case always put into relation with the flow resistance coefficient of a brake flap without any passages. A resistance curve 31 in this case represents the relative change of resistance for the case in which only the passages 8 close to the fuselage are provided. Another resistance curve 32 illustrates the case that only the passage 7 distant from the fuselage is formed in the brake flap. The case of the brake flap 6 which has both the passages 8 close to the fuselage as well as the passage 7 distant from the fuselage is represented by a resistance curve 33. The resistance curves 31, 32 and 33, whose accuracy is within the one-percent range, show a change of resistance in the single-digit percent range. Therefore, the passages 7 and 8 do not significantly affect the achievable drag.

In closing, it is noted that features and properties that were described in connection with a particular exemplary embodiment can also be combined with another exemplary embodiment even if this is precluded for compatibility reasons.

Finally, reference is made to the fact that, in the claims and in the description, the singular includes the plural unless the context shows otherwise. In particular, both the singular as well as the plural are what is meant when the indefinite article is used.

What is claimed is:

1. Device for generating aerodynamic resistance on an aircraft, comprising at least one brake flap that can be swung out into an airflow approaching a vertical tail, wherein the at least one brake flap is provided with at least one slot-shaped passage whose longitudinal axis extends transversely to a pivot axis of the brake flap and which serves for increasing the momentum of the air in the wake of the brake flap.

2. Device according to claim 1,
wherein the thickness of the brake flap decreases from an end close to the fuselage towards an end distant from the fuselage.

3. Device according to claim 1,
wherein the at least one passage is formed by a slot formed in the brake flap which extends along a longitudinal axis from an end close to the fuselage to an end distant from the fuselage.

4. Device according to claim 1,
wherein a passage is disposed in the area of the brake flap distant from the fuselage.

5. Device according to claim 4,
wherein the passage distant from the fuselage is centered on a longitudinal axis of the brake flap.

6. Device according to claim 4,
wherein the passage in the area of the brake flap distant from the fuselage has a trapezoidal cross-sectional profile.

7. Device according to claim 6,
wherein an underside close to the fuselage of the passage has a width of between 0.25 B and 0.35 B of a base width B of the brake flap and a top side distant from the fuselage of the passage has a width of between 0.15 B and 0.2 B of the base width B of the brake flap and that the length of the passage is between 0.25 L and 0.35 L of the length L of the brake flap.

8. Device according to claim 1,
wherein at least one passage is disposed in the area of the brake flap close to the fuselage.

9. Device according to claim 8,
wherein the brake flap, in an area close to the fuselage, has at least two passages.

10. Device according to claim 8,
wherein the passage close to the fuselage is disposed offset relative to a longitudinal axis of the brake flap.

11. Device according to claim 8,
wherein the passage close to the fuselage is offset, relative to the longitudinal axis of the brake flap, by between 0.15 B and 0.25 B of a base width B of the brake flap.

12. Device according to claim 8,
wherein the passages have a rectangular cross section and that a width of a passage is between 0.1 B to 0.2 B of the base width B of the brake flap and that a length of the passage is between 0.25 L and 0.35 L of the length of the brake flap.

13. Aircraft comprising a device for generating aerodynamic resistance by means of a brake flap that can be swung out into an airflow surrounding the aircraft and approaching a vertical tail, wherein the at least one brake flap is provided with at least one slot-shaped passage whose longitudinal axis extends transversely to a pivot axis of the brake flap and which serves for increasing the momentum of the air in the wake of the brake flap.

14. Aircraft according to claim 13,
wherein a symmetry plane of the brake flap extending along the longitudinal axis of the aircraft coincides with a symmetry plane of the vertical tail extending along the longitudinal axis of the aircraft.

15. Method for generating aerodynamic resistance on an aircraft, wherein a brake flap is swung out into an airflow surrounding the aircraft and approaching a vertical tail, wherein the at least one brake flap is provided with at least one slot-shaped passage whose longitudinal axis extends transversely to a pivot axis of the brake flap and which serves for increasing the momentum of the air in the wake of the brake flap.
